(19) United States
(12) Patent Application Publication
(10) Pub. No.: US 2012/0120933 A1
(43) Pub. Date: May 17, 2012

(54) METHOD FOR ENHANCED RADIO RESOURCE MANAGEMENT IN A PUBLIC LAND MOBILE NETWORK

(75) Inventor: Rainer Schatzmayr, Bonn (DE)

(73) Assignee: DEUTSCHE TELEKOM AG, Bonn (DE)

(21) Appl. No.: 13/294,374

(22) Filed: Nov. 11, 2011

Related U.S. Application Data
(60) Provisional application No. 61/412,857, filed on Nov. 12, 2010.

(30) Foreign Application Priority Data
Nov. 12, 2010 (EP) 10 014 546.5

(51) Int. Cl. H04W 84/02; H04W 12/06; H04W 48/20

(52) U.S. Cl. 370/338

(57) ABSTRACT

A method for enabling a mobile terminal to access a wireless local area network, the method including: receiving, at the mobile terminal, a first set of data from a WLAN (wireless local area network) login server module of a public land mobile network, wherein the first set of data is related to authentication information required by the wireless local area network for granting access to the mobile terminal; storing, by a WLAN login client module of the mobile terminal, a second set of data related to the authentication information required by the wireless local area network within a subscriber identity module of the mobile terminal; and upon access to the wireless local area network being requested by the mobile terminal, transmitting, by the WLAN login client module, the authentication information from the mobile terminal to the wireless local area network.

### CROSS-REFERENCE TO RELATED APPLICATIONS

This patent application claims priority to U.S. Provisional Patent Application No. 61/412,857, filed on Nov. 12, 2010, and European Patent Application No. EP 10 014 546.5, filed on Nov. 12, 2010, both of which are hereby incorporated by reference herein in their entireties.

### FIELD

The present invention relates to a method, a public land mobile network, a mobile terminal and a program for enabling a mobile terminal to have access to a wireless local area network via a first radio interface of the mobile terminal, wherein the wireless local area network requires at least one authentication information to grant access to the mobile terminal. The mobile terminal has access to a public land mobile network according to any standard, such as GERAN, UTRAN, LTE/E-UTRAN, LTE-Advanced, cdma2000, WiMAX, WiBro etc, and access to the wireless local area network is provided to the mobile terminal via the operator of the public land mobile network to which the mobile terminal is connected.

### BACKGROUND

Access points of wireless local area networks are used to provide wireless connectivity to mobile terminals. There are so-called open (public) wireless local area networks (having associated access points) and so-called closed (private) wireless local area networks (having associated access points).

An open wireless local area network is usually provided in public environments like airports, restaurants, railway stations, etc. Its main characteristic is that it allows a mobile terminal to establish an unencrypted connection to the wireless local area network (or the access point of the wireless local area network). The access to specific services provided by the wireless local area network can be controlled by mechanisms that provide an authentication of the user trying to have access to the service. These mechanisms are usually based on credentials like a username and/or a password. Once the user (the mobile terminal) is authenticated, the corresponding mobile terminal is authorized to have access to the services of the wireless local area network. E.g., a user (a mobile terminal) can be authenticated in a public wireless local area network (for example in a hotel or the like) by entering a username and a password, and by providing a valid username and a valid corresponding password, internet connectivity services is provided.

A closed wireless local area network is usually deployed in a home or enterprise environment. In this case, the communication between the mobile terminal and the wireless local area network is usually encrypted, ensuring that other terminals cannot read the messages being exchanged between the mobile terminal and the wireless local area network (or the access point of the wireless local area network). The encryption is usually performed through the usage of encryption keys that have to be exchanged between the mobile terminal and the wireless local area network (or the access point of the wireless local area network). This is usually performed by the user that configures the WLAN interface of the mobile terminal by using the encryption keys used for the wireless local area network. Once the mobile terminal is able to establish an encrypted communication to the wireless local area network (or the access point of the wireless local area network), the mobile terminal can be authorized to access specific services. In many cases, such additional authorization is not performed and the use of the encryption is assumed to represent an authorization.

In case that an access of a mobile terminal to a wireless local area network (or the access point of the wireless local area network) is desired, there is the problem of how to transmit the credentials in a secure manner to the mobile terminal. This is especially true for a first time access of a specific mobile terminal to a specific wireless local area network (or the access point of the wireless local area network). Subsequent access is usually simpler as the mobile terminal can store the credentials locally. The delivery of credentials is usually performed by re-directing the user (of the mobile terminal) during the first access to the public wireless local area network (or the access point of the wireless local area network) to usually a HTTP page that provides the credentials (usually after entering either a credit card information or a voucher code). The credentials can also be provided to the user of the mobile terminal via an SMS after the user enters the required information to the HTTP page. Whichever way is chosen to deliver the credentials, an interaction of the user of the mobile terminal is required, at least when accessing a specific wireless local area network (or the access point of the wireless local area network) for the first time.

In a case where a mobile terminal is to be connected to a private wireless local area network (or the access point of the wireless local area network), there exists the problem of how to provide the encryption keys in a secure manner to the mobile terminal. Encryption keys are usually valid in a single wireless local area network (or the access point of the wireless local area network) or restricted to an enterprise. It is possible to transmit such encryption keys, e.g., in writing and in a confidential manner. Once the user of the mobile terminal has received the encryption keys, a configuration has to occur in the WLAN interface of the mobile terminal.

Presently, several mechanisms have been proposed to facilitate the actions to be performed such that a mobile terminal is enabled to have access to a wireless local area network (or the access point of the wireless local area network). These mechanisms include solutions such as EAP-SIM (EAP for GSM Subscriber Identity) and EAP-AKA (Extensible Authentication Protocol for UMTS Authentication and Key Agreement). These mechanisms provide authentication functionality for mobile terminals based on mechanisms derived from Global System of Mobile Communication (GSM)/Universal Mobile Telecommunication System (UMTS) networks. The authentication algorithms of the public land mobile network are re-used to provide an authentication of the subscriber identity module (SIM) of the mobile terminal. The main problem with this solution is that it requires support for EAP-SIM/EAP-AKA in the wireless local area network (or the access point of the wireless local area network) and only works in wireless local area networks (or the access points of the wireless local area network) that are connected to the infrastructure of the operator of the public land mobile network to which the mobile terminal is connected. Additional methods comprise EAP-TLS (Extensible Authentication Protocol over Transport Layer Security) and similar EAP variants based on a certificate stored in the mobile terminal. These mechanisms require the existence of credentials on the mobile terminal and hence a challenge lies in questions where to store such credentials on the mobile terminal in a secure manner.

With regard to closed wireless local area networks, a mechanism called WPS (Wireless Protected Setup) is presently known that provides a possibility to easily configure the encryption keys (like WPA (Wi-Fi Protected Access) keys or WPA2 keys) on the mobile terminal. The main drawback of this method is that WPS requires actions to be performed on the wireless local area network (or the access points of the wireless local area network) and on the mobile terminal simultaneously, like pressing a button at the same time, or entering specific keys in the access point of the wireless local area network. This becomes relatively cumbersome in a public wireless local area network environment.

### SUMMARY

An embodiment of the present invention provides a method for enabling a mobile terminal to access a wireless local area network. The method includes: receiving, at the mobile terminal, a first set of data from a WLAN (wireless local area network) login server module of a public land mobile network, wherein the first set of data is related to authentication information required by the wireless local area network for granting access to the mobile terminal; storing, by a WLAN login client module of the mobile terminal, a second set of data related to the authentication information required by the wireless local area network within a subscriber identity module of the mobile terminal; and upon access to the wireless local area network being requested by the mobile terminal, transmitting, by the WLAN login client module, the authentication information from the mobile terminal to the wireless local area network; wherein the WLAN login client module transmits a first request message to the WLAN login server module, the first request message specifying the wireless local area network so as to allow the WLAN login server module to transmit the first set of data to the WLAN login client module; wherein the mobile terminal transmits a second request message to the wireless local area network so as to trigger transmission of a third set of data from the wireless local area network to the public land mobile network, the third set of data being related to the authentication information and stored in the WLAN login server module.

### BRIEF DESCRIPTION OF THE DRAWINGS

FIG. 1 schematically illustrates a mobile terminal, a public land mobile network and a wireless local area network according to the present invention.

FIG. 2 schematically illustrates an exemplary transmission diagram.

FIG. 3 schematically illustrates an exemplary transmission diagram.

FIG. 4 schematically illustrates an exemplary transmission diagram.

### DETAILED DESCRIPTION

In order to overcome the limitations of the conventional methods of enabling a mobile terminal to have access to a wireless local area network, an embodiment of the present invention exchanges data between a public land mobile network and the mobile terminal and to use the data to enable the mobile terminal to have access to the wireless local area network in a convenient manner, for example, in an automatic manner without relying on an interaction with the user of the mobile terminal.

An embodiment therefore provides a method, a public land mobile network (PLMN), a mobile terminal, and a program for enabling the mobile terminal to have access to a wireless local area network, wherein the exchange of data for providing access to the wireless local area network occurs in a convenient way for the user of the mobile terminal.

An embodiment of the present invention includes a method for enabling a mobile terminal to have access to a wireless local area network via a first radio interface of the mobile terminal, wherein the wireless local area network requires at least one authentication information to grant access to the mobile terminal, wherein the mobile terminal comprises a subscriber identity module and a second radio interface to a public land mobile network, wherein the public land mobile network comprises a WLAN login server module, and wherein the mobile terminal comprises a WLAN login client module, wherein the method comprises the steps of:

transmitting a first set of data from the WLAN login server module of the public land mobile network to the mobile terminal, the first set of data being related to the authentication information required by the wireless local area network,

storing a second set of data related to the authentication information required by the wireless local area network within the subscriber identity module of the mobile terminal using the WLAN login client module, and

if access to the wireless local area network is requested by the mobile terminal, transmitting the authentication information from the mobile terminal to the wireless local area network using the WLAN login client module.

Thereby, according to the method, access to the wireless local area network can be granted to the mobile terminal in a convenient manner.

As used herein, the term “authentication information” relates to authentication information such as a username and a password or only a username or only a password, and may also relates to an encryption information or an encryption key such as the WPA key or the WPA2 key requested by a protected wireless local area network from any mobile terminal requesting access to the wireless local area network.

The term “mobile terminal” relates to a device having a WLAN interface (first radio interface), a subscriber identity module (SIM card), and mobile connectivity (by the second radio interface to the public land mobile network). The mobile terminal can be a handset device like a mobile phone, or a computing device like a laptop. The operating system is considered part of the mobile terminal.

The term “access point” relates, for example, to a “WLAN layer 2” device, a WLAN enabled router, an integrated access device or similar devices.

In an embodiment, the subscriber identity module of the mobile terminal is the subscriber identity module used by the mobile terminal to have access to the public land mobile network. For example, in a case where the public land mobile network the mobile terminal is potentially connected to is a mobile terminal according to the Global System of Mobile Communication (GSM) standard, the subscriber identity module is a SIM-card according to the Global System of Mobile Communication (GSM) standard. In a case where the public land mobile network the mobile terminal is potentially connected to is a mobile terminal according to the Universal Mobile Telecommunication System (UMTS), the subscriber identity module is an USIM-card according to the Universal Mobile Telecommunication System (UMTS).

According to an embodiment, after the reception of the first set of data (related to the authentication information required by the wireless local area network), data are stored in the mobile terminal using the WLAN login client module, wherein these data are hereinafter also called a second set of data. The second set of data (which is stored in a memory device or a memory element of the mobile terminal, for example a memory device or a memory element within the subscriber identity module or protected by protection methods of the subscriber identity module of the mobile terminal) can be identical to the first set of data but it can also differ from the first set of data (transmitted from the WLAN login server module to the mobile terminal).

According to an embodiment, a method comprises the step of the WLAN login client module of the mobile terminal transmitting a request message to the WLAN login server module of the public land mobile network, the request message specifying the wireless local area network allowing the WLAN login server module of the public land mobile network to transmit the first set of data to the WLAN login client module of the mobile terminal.

Thereby, it is advantageously possible to easily and conveniently transfer the first set of data from the public land mobile network to the mobile terminal for a specific wireless local area network requested or recognized by the mobile terminal.

According to yet another embodiment, the request message of the WLAN login client module is transmitted to the WLAN login server module in an automatic manner after the mobile terminal having recognized the wireless local area network.

Thereby, it is advantageously possible to easily and conveniently transfer the request message from the mobile terminal to the public land mobile network for a specific wireless local area network requested or recognized by the mobile terminal.

According to another embodiment, the method comprises the steps of

the wireless local area network sending a third set of data to the WLAN login server module of the public land mobile network, the third set of data being related to the authentication information required by the wireless local area network, and/or

the mobile terminal transmitting a further request message to the wireless local area network in view of triggering the transmission of a third set of data from the wireless local area network to the public land mobile network, the third set of data being stored in the WLAN login server module of the public land mobile network, and the third set of data being related to the authentication information.

Thereby, it is advantageously possible to easily and conveniently transfer data to the public land mobile network that are indicative of the authentication information to be used in connection with a specific wireless local area network, these data transferred to the public land mobile network are hereinafter also called a third set of data.

It is to be understood that the first set of data, the second set of data and the third set of data are not necessarily different. These sets of data can either be

identical, or

the first set of data be identical to the second set of data (but not to the third set of data), or

the second set of data be identical to the third set of data (but not to the first set of data), or

the first set of data be identical to the third set of data (but not to the second set of data).

According to an embodiment, the transmission of the authentication information from the mobile terminal to the wireless local area network is transparent for the wireless local area network. This means that the wireless local area network as a whole or any component of the wireless local area network (such as an access point of the wireless local area network) does not need to comply with specific requirements in order to be used in connection with the method, the public land mobile network or the mobile terminal of the present invention. Thereby, it is advantageously possible to use any already installed wireless local area network or component of a wireless local area network.

Another embodiment of the present invention also relates to a public land mobile network for enabling a mobile terminal to have access to a wireless local area network via a first radio interface of the mobile terminal, wherein the wireless local area network requires at least one authentication information to grant access to the mobile terminal, wherein the mobile terminal comprises a subscriber identity module and a second radio interface to the public land mobile network, wherein the public land mobile network comprises a WLAN login server module, and wherein the mobile terminal comprises a WLAN login client module, wherein the public land mobile network is configured such that a first set of data from the WLAN login server module of the public land mobile network is transmitted to the mobile terminal, the first set of data being related to the authentication information required by the wireless local area network, wherein a second set of data related to the authentication information is stored within the subscriber identity module of the mobile terminal using the WLAN login client module, and wherein the authentication information is transmitted from the mobile terminal to the wireless local area network using the WLAN login client module in case that access to the wireless local area network is requested by the mobile terminal.

According to an embodiment:

the public land mobile network is configured such that on reception of a request message to the WLAN login server module of the public land mobile network from the WLAN login client module of the mobile terminal, the transmission of the first set of data is provided from the WLAN login server module of the public land mobile network to the WLAN login client module of the mobile terminal, and/or

the public land mobile network is configured to receive a third set of data from the wireless local area network to be stored in the WLAN login server module of the public land mobile network, the third set of data being related to the authentication information required by the wireless local area network.

Furthermore, an embodiment relates to a mobile terminal being enabled to have access to a wireless local area network via a first radio interface of the mobile terminal, wherein the wireless local area network requires at least one authentication information to grant access to the mobile terminal, wherein the mobile terminal comprises a subscriber identity module and a second radio interface to a public land mobile network, wherein the public land mobile network comprises a WLAN login server module, and wherein the mobile terminal comprises a WLAN login client module, wherein the mobile terminal is configured such that a first set of data is received by the WLAN login client module from the WLAN login server module of the public land mobile network, the first set of data being related to the authentication information required by the wireless local area network, wherein a second set of data related to the authentication information is stored within the subscriber identity module of the mobile terminal using the WLAN login client module, and wherein the mobile terminal is configured such that the authentication information is transmitted from the mobile terminal to the wireless local area network using the WLAN login client module in case that access to the wireless local area network is requested by the mobile terminal.

According to an embodiment:

the mobile terminal is configured such that a request message is generated by the mobile terminal using the WLAN login client module and sent to the public land mobile network in view of the reception of the first set of data by the WLAN login client module of the mobile terminal, and/or

the mobile terminal is configured to send a further request message to the wireless local area network in order to trigger the transmission of a third set of data from the wireless local area network to the public land mobile network, the third set of data being stored in the WLAN login server module of the public land mobile network, and the third set of data being related to the authentication information.

Another embodiment further relates to a program comprising a computer readable program code for controlling a public land mobile network or a mobile terminal according to the inventive method described herein. Yet another further embodiment also relates to a computer program product comprising the aforementioned program.

Particular embodiments will be described further herein and with reference to certain drawings, but it will be appreciated that the invention is not limited to those particular exemplary embodiments described herein. The drawings described are only exemplary and are non-limiting. It will further be appreciated that in the drawings, the size of some of the elements may be exaggerated and not drawn on scale for illustrative purposes.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

According to an embodiment, a method for enabling a mobile terminal to have access to a wireless local area network via a first radio interface of the mobile terminal is described. The inventive method is also called “operator assisted WLAN login”. This means that the operator of the public land mobile network (to which the mobile terminal is connected or at least to which the mobile terminal has been connected) is involved in providing to the mobile terminal the necessary credential information obtain access to the wireless local area network, i.e. to an access point of the wireless local area network.

In FIG. 1, a mobile terminal 20, a public land mobile network 10 and a wireless local area network 30 are shown. The wireless local area network 30 comprises one or a plurality of access points. For example, one access point 31 is shown in FIG. 1 and designated by means of reference sign 31. The mobile terminal 20 comprises a subscriber identity module 23, and a first radio interface 21 that is able to establish a radio link to the wireless local area network 30 (or to the access point 31 of the wireless local area network 30), according to the WLAN standard or according to one of the WLAN standards (IEEE 802.11x). The public land mobile network 10 comprises a transceiver entity 12 such as a base station, a NodeB, an eNodeB or another transceiver system so that a radio link between the public land mobile network 10 and a second radio interface 22 the mobile terminal 20 can be established according to a mobile communication standard such as GERAN, UTRAN, LTE/E-UTRAN, LTE-Advanced, cdma2000, WiMAX, WiBro etc. The wireless local area network 30 comprises a server 32 of the WLAN infrastructure.

According to the present invention, the mobile terminal 20 comprises a WLAN login client module 25 and the public land mobile network 10 comprises a WLAN login server module 15. The WLAN login client module 25 and the WLAN login server module 15 serve to exchange data that ensure that the mobile terminal is able successfully login to the wireless local area network 30.

In a case where the WLAN login client module 25 needs to communicate with the WLAN login server module 15, mobile connectivity between the mobile terminal 20 and the public land mobile network 10 is established, specifically a mobile connectivity between the subscriber identity module 23 and the infrastructure of the public land mobile network 10. According to an embodiment, this connectivity can be implemented, e.g., by means of an SMS communication (Short Message System) or by means of a data channel.

In an embodiment, the WLAN login client module 25 is implemented as a SIM card application, either partially or completely. For example, the WLAN login client module 25 can be downloaded to the subscriber identity module 23 of the mobile terminal 20, for example via an over-the-air remote device management system available to the operator of the public land mobile network 10.

The operator assisted WLAN login in an embodiment refers to a method where WLAN login client module 25 stores information or data in relation to the information needed to obtain access to the wireless local area network 30 and for using the services of the wireless local area network 30. Such information (needed to obtain access to the wireless local area network 30) is hereinafter also called authentication information and designated by means of reference sign 50. The information stored or memorized in the WLAN login client module 25 corresponding to the authentication information is hereinafter also called second set of data and designated by means of reference sign 52. In an embodiment, in order for the WLAN login client module 25 to be able to store the second set of data 52 (for example, in the subscriber identity module 23 of the mobile terminal 20), a first set of data 51 is transferred from the public land mobile network 10 (preferably the WLAN login server module 15 of the public land mobile network 10) to the mobile terminal 20 and to the WLAN login client module 25.

According to an embodiment, the second set of data 52 is stored in the WLAN login client module 25 such that a plurality of second sets of data 52 (corresponding to the authentication information 50 of a plurality of different wireless local area networks or access points of wireless local area networks) are stored in the subscriber identity module 23 of the mobile terminal 20. The mobile terminal 20 discovers or recognizes different wireless local area networks 30 and requests the corresponding pieces of authentication information 50 from the public land mobile network 10, thereby creating a database inside the mobile terminal 20 that is self-learning.

The WLAN login client module 25 either continuously scans the radio spectrum for available wireless local area networks (especially via scanning the WLAN SSID information of different networks), or the WLAN login client module 25 is called whenever the mobile terminal 20 detects a WLAN SSID. The WLAN login client module 25 can either be called by the mobile terminal 20 for all WLAN SSIDs detected, or only for WLAN SSIDs detected for the first time by the mobile terminal.

In an embodiment, the WLAN login client module 25 memorizes or stores the second set of data 52 (or the plurality of second sets of data 52) within a SIM card. Thereby, it is easily possible to transfer the needed authentication information 50 from one device to another device by simply exchanging the SIM card.

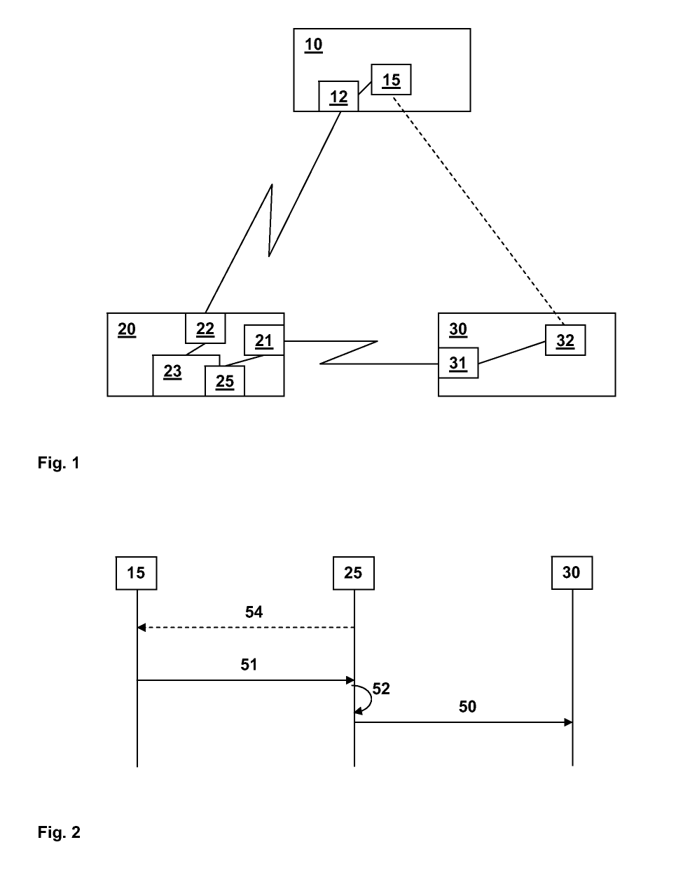

Hereinafter, an embodiment is explained with respect to FIGS. 1 and 2.

Once the WLAN login client module 25 detects a new WLAN SSID it checks whether the WLAN login client module 25 already has the authentication information necessary to access the corresponding wireless local area network 30 or whether it needs additional information.

In a case where the WLAN login client module 25 already has the required information to access the wireless local area network 30 (stored in the database of (plurality of) the second set(s) of data inside the subscriber identity module 23 (preferably the SIM card) of the mobile terminal 20), it either configures the first radio interface (WLAN interface) 21 of the mobile terminal 20 directly, or it provides the information to the mobile terminal 20 so that the mobile terminal 20 is able to configure itself. Either way, the mobile terminal 20 is able to connect to the wireless local area network 30 (or access point of the wireless local area network) without any user intervention.

In a case where the WLAN login client module 25 detects a new WLAN SSID and does not find the authentication information 50 necessary to access the wireless local area network (or access point of the wireless local area network), it contacts the WLAN login server module 15 via the second radio interface 22 of the mobile terminal 20. This connectivity is provided by the public land mobile network 10, e.g. in the form of an SMS transmission or of a data connection. The operator assisted WLAN login method is executed by the WLAN login client module 25 sending a request message 54 (preferably including the WLAN SSID) to the WLAN login server module 15, and waits for a response. When the WLAN login server module 15 receives a request message 54 (preferably comprising the WLAN SSID information or another information specifying the requested wireless local area network 30), the WLAN login server module 15 checks whether the requested information is present and (in the affirmative case) sends the first set of data 51 to the WLAN login client module 25. The WLAN login client module 25 then either configures the first radio interface (WLAN interface) 21 of the mobile terminal 20 directly, or it provides the information to the mobile terminal 20 so that the mobile terminal 20 is able to configure itself. The mobile terminal 20 is then able to connect to the wireless local area network 30 (or access point of the wireless local area network) without any user intervention.

If the WLAN login server module 15 does not find any information related to the authentication information 50 of the requested wireless local area network 30, it can either report this result to the WLAN login client module 25. Otherwise, the WLAN login server module 15 can contact the operator of the wireless local area network 30 (or the provider of the wireless local area network 30) and request to have the corresponding information transmitted.

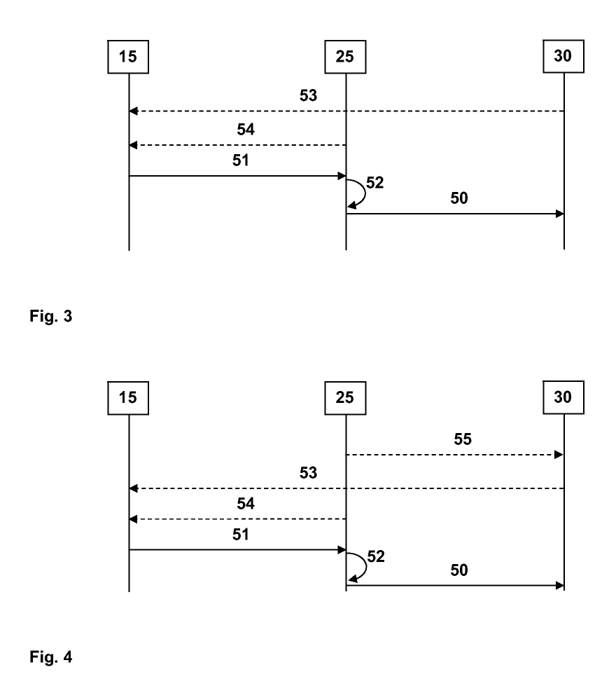

Another embodiment is represented by FIG. 3: The wireless local area network 30 (or a central entity of the wireless local area network 30) sends a third set of data 53 to the public land mobile network 10, for example to the WLAN login server module 15 in order to assure that the relevant data for granting access to the wireless local area network 30 can be distributed by the WLAN login server module 15 to the requesting mobile terminal(s) 20. Then, further steps as described above with respect to FIG. 2 may be taken to facilitate the connection without user intervention.

Yet another further embodiment is represented by FIG. 4: the transmission of the third set of data 53 from the wireless local area network 30 (or a central entity of the wireless local area network 30) to the public land mobile network 10 is triggered by a request message 55 which is sent from the WLAN login client module 25 to the wireless local area network 30, in order to assure that the relevant data for granting access to the wireless local area network 30 can be distributed by the wireless local area network 30 (e.g., by transmitting the third set of data 53 to the WLAN login server module 15) as described above with respect to FIG. 3.

In an embodiment. the authentication information 50 (and hence the first set of data 51, the second set of data 52 and the third set of data 53) relate to one or a plurality out of the following:

the WLAN SSID,

whether the wireless local area network 30 corresponding to the WLAN SSID is open or closed,

the credentials needed to authenticate the mobile terminal 20, and

the encryption keys needed to setup a connection in a closed wireless local area network 30.

1. A method for enabling a mobile terminal to access a wireless local area network, the method comprising:
receiving, at the mobile terminal, a first set of data from a WLAN (wireless local area network) login server module of a public land mobile network, wherein the first set of data is related to authentication information required by the wireless local area network for granting access to the mobile terminal;
storing, by a WLAN login client module of the mobile terminal, a second set of data related to the authentication information required by the wireless local area network within a subscriber identity module of the mobile terminal; and
upon access to the wireless local area network being requested by the mobile terminal, transmitting, by the WLAN login client module, the authentication information from the mobile terminal to the wireless local area network;
wherein the WLAN login client module transmits a first request message to the WLAN login server module, the first request message specifying the wireless local area network to allow the WLAN login server module to transmit the first set of data to the WLAN login client module;
wherein the mobile terminal transmits a second request message to the wireless local area network so as to trigger transmission of a third set of data from the wireless local area network to the public land mobile network, the third set of data being related to the authentication information and stored in the WLAN login server module.

2. The method according to claim 1, wherein the mobile terminal comprises a first radio interface to the wireless local area network and a second radio interface to the public land mobile network.

3. The method according to claim 1, wherein the first request message is transmitted to the WLAN login server module in an automatic manner after the mobile terminal recognizes the wireless local area network.

4. The method according to claim 1, wherein the wireless local area network sends the third set of data to the WLAN login server module.

5. The method according to claim 1, wherein the transmission of the authentication information from the mobile terminal to the wireless local area network (30) is transparent for the wireless local area network.

6. A public land mobile network for enabling a mobile terminal to access a wireless local area network, the public land mobile network comprising:
a WLAN (wireless local area network) login server module, configured to:
transmit a first set of data to the mobile terminal, wherein the first set of data is related to authentication information required by the wireless local area network for granting access to the mobile terminal, and to transmit the first set of data a WLAN login client module of the mobile terminal upon reception of a first request message, a second set of data related to the authentication information being stored within a subscriber identity module of the mobile terminal using the WLAN login client module; and
store a third set of data received from the wireless local area network at the public land mobile network, wherein the third set of data is related to the authentication information;
wherein the authentication information is transmitted from the mobile terminal to the wireless local area network by the WLAN login client module upon access to the wireless local area network being requested by the mobile terminal.

7. The public land mobile network of claim 6, wherein the mobile terminal comprises a first radio interface to the wireless local area network and a second radio interface to the public land mobile network.

8. A mobile terminal for accessing a wireless local area network, the mobile terminal comprising:
a first radio interface to the wireless local area network;
a second radio interface to a public land mobile network;
a WLAN (wireless local area network) login client module, configured to receive a first set of data from a WLAN login server module of the public land mobile network, wherein the first set of data is related to authentication information required by the wireless local area network for granting access to the mobile terminal, and to transmit the authentication information to the wireless local area network upon access to the wireless local area network being requested, and further configured to generate and transmit a first request message to the public land mobile network based on reception of the first set of data; and
a subscriber identity module configured to store a second set of data related to the authentication information using the WLAN login client module;
wherein the mobile terminal is configured to send a second request message to the wireless local area network so as to trigger the transmission of a third set of data from the wireless local area network to the public land mobile network, wherein the third set of data is related to the authentication information and is stored in the WLAN login server module of the public land mobile network.

9. A tangible, non-transient computer-readable medium having computer-executable instructions stored thereon for enabling a mobile terminal to access a wireless local area network, the computer-executable instructions comprising:
instructions for receiving a first set of data from a WLAN (wireless local area network) login server module of a public land mobile network, wherein the first set of data is related to authentication information required by the wireless local area network for granting access to the mobile terminal;
instructions for storing, a second set of data related to the authentication information required by the wireless local area network within a subscriber identity module of the mobile terminal;
instructions for transmitting the authentication information from the mobile terminal to the wireless local area network upon access to the wireless local area network being requested by the mobile terminal;
instructions for transmitting a first request message to the WLAN login server module, the first request message specifying the wireless local area network to allow the WLAN login server module to transmit the first set of data to the WLAN login client module; and
instructions for transmitting a second request message to the wireless local area network that triggers transmission of a third set of data from the wireless local area network to the public land mobile network, the third set of data being related to the authentication information and stored in the WLAN login server module.
